(19) United States
(12) Patent Application Publication
(10) Pub. No.: US 2026/0227177 A1
(43) Pub. Date: Aug. 6, 2026

(54) SYSTEM AND METHOD FOR MEASURING A CLEARANCE BETWEEN A ROTARY VANE AND A CASING OF A TURBINE ENGINE

(71) Applicant: SAFRAN AIRCRAFT ENGINES, PARIS (FR)

(72) Inventors: Bruno Marie-Joseph Anne Padoue HAENTJENS, MOISSY-CRAMAYEL (FR); Benoit Bernard Maurice LEBLANC, MOISSY-CRAMAYEL (FR); Yoann GODEFROY, MOISSY-CRAMAYEL (FR)

(73) Assignee: SAFRAN AIRCRAFT ENGINES, PARIS (FR)

(21) Appl. No.: 19/562,126

(22) Filed: Mar. 10, 2026

Related U.S. Application Data
(63) Continuation of application No. PCT/FR2024/051202, filed on Sep. 13, 2024.

(30) Foreign Application Priority Data
Sep. 15, 2023 (FR) 23/09766

(51) Int. Cl. G01B 11/14

(52) U.S. Cl. CPC G01B 11/14

(57) ABSTRACT

A system for measuring a clearance between a rotating blade and a casing of a turbomachine includes a removable fastening device provided with a locking mechanism to maintain the mounted position of the measurement system on the casing, a retractable stop mechanism provided with a guide and a finger that hold the rotating blade in a measurement position, a remote acquisition device that measures at least one clearance between the rotating blade and the casing when the removable fastening device is in the mounted position and the retractable stop mechanism is in the deployed position, and a plate to which the removable fastening device, the retractable stop mechanism and the remote acquisition device are attached.

### CROSS-REFERENCE TO RELATED APPLICATIONS

This application is a continuation of International Application No. PCT/FR2024/051202, filed on Sep. 13, 2024, which claims priority to and the benefit of FR 23/09766 filed on Sep. 15, 2023. The disclosures of the above applications are incorporated herein by reference.

### FIELD

The present disclosure relates to a system for measuring a clearance between a rotating blade and a casing of a turbomachine. In particular, the measurement system is suitable for fan blades whose main function is to bring the incoming air to a certain level of compression.

### BACKGROUND

The statements in this section merely provide background information related to the present disclosure and may not constitute prior art.

It is known to verify the correct sizing of the clearance between a rotating blade and a casing to provide compliance of the turbomachine. Typically, for a fan blade, the clearance must correspond to the value specified during the design to within one hundredth of a millimeter.

Excessive clearance may have a negative impact on the engine operability and engine performance. Conversely, insufficient clearance gives rise to risks of wear and mechanical contact between the rotating blade and the casing.

One possibility to measure the correct sizing of the clearance consists in using shims of known thicknesses that are manually slid between the rotating blade and the casing. This is satisfactory in that the correct sizing can be easily verified.

However, this type of measurement has drawbacks. For the operator responsible for performing the measurements, it may be time-consuming and tedious to insert the shim at the desired locations, as several blades at different clock positions must be tested. The operator may also limit friction of the shim so as not to damage the rotating blade or the casing.

This manual measurement also raises the question of measurement quality, as it is likely to fluctuate depending on the circumstances, in particular if the operator engages the shim beyond the axial measurement position. “Axial” refers to the rotational axis of the turbomachine.

### SUMMARY

This section provides a general summary of the disclosure and is not a comprehensive disclosure of its full scope or all of its features.

The present disclosure aims to resolve all or part of the drawbacks mentioned above.

To this end, the present disclosure relates to a system for measuring a clearance between a rotating blade and a casing of a turbomachine, the measurement system comprising: a removable fastening device shaped to adapt, in a form-fitting manner, to a complementary location of the casing in a mounted position, the removable fastening device being provided with a locking mechanism to maintain the mounted position of the measurement system on the casing, a retractable stop mechanism provided with a guide and a finger capable of being arranged relative to the guide in a deployed position in which the finger is configured to hold the rotating blade in a measurement position, a remote acquisition device configured to measure at least one clearance between the rotating blade and the casing when the removable fastening device is in the mounted position and the retractable stop mechanism is in the deployed position, a plate to which the removable fastening device, the retractable stop mechanism and the remote acquisition device are attached.

Thus, the measurement system is a specific tool with a device for remotely acquiring a measurement that can be removably fastened to the casing and block the rotating blade in the measurement position.

For the operator, installing the measurement system in the mounted position is quick and easy. Positioning the rotating blade is also simple to perform, since the measurement position is reached by abutment against the finger.

In addition, acquiring the measurement remotely eliminates the risks of scratching or damaging the rotating blade or the casing.

The accurate two-stage positioning of the measurement system mounted position then measurement position-provides good reproducibility and good repeatability of clearance measurements.

According to one aspect of the present disclosure, the remote acquisition device comprises at least one sensor configured to measure a clearance corresponding to a minimum distance between the rotating blade and the casing in a corresponding measurement plane of the sensor.

In other words, the sensor is configured to detect in the measurement plane a point on the rotating blade and a point on the casing with the smallest distance and then to measure this distance.

This type of measurement is advantageous as it is non-intrusive and avoids any scratching or damage to the rotating blade and/or the casing.

According to one aspect of the present disclosure, the measurement system comprises at least one device for adjusting the relative position of the at least one sensor with respect to the plate so as to define the positioning of the corresponding measurement plane of the sensor with respect to the plate.

This arrangement contributes to the reliability of the clearance measurement by the sensor as the measurement plane can be accurately defined to correspond to the exact desired measurement location between the rotating blade and the casing.

According to one aspect of the present disclosure, the at least one measurement plane is positioned so as to be transverse and in particular normal to the casing at the location of the measured clearance.

According to one aspect of the present disclosure, the adjustment device comprises a support configured to receive the corresponding sensor, the support being provided with an adjustment pin whose movement allows the position of the sensor with respect to the plate to be changed.

In one aspect, the adjustment device comprises a clamping element to maintain the relative position of the support with respect to the plate. In particular, the clamping element comprises two screws configured to cooperate with two corresponding threads on the support. The screws are configured to extend through at least one through-opening in the plate to ensure that the support is secured to the plate.

According to one aspect of the present disclosure, the remote acquisition device comprises three sensors configured to measure three clearances corresponding to three minimum distances between the rotating blade and the casing in three corresponding measurement planes.

Three measurement planes are thus defined to measure three clearances at three different locations between the rotating blade and the casing. performing these three measurements is quick and reliable. In addition, no handling is needed by the operator once the measurement system is in the mounted position and in the measurement position.

Each sensor is associated with a corresponding adjustment device of the measurement system. The sensors are arranged so that the three measurement planes are substantially parallel.

According to one aspect of the present disclosure, the at least one sensor is a laser profilometer adapted to identify two distinct elements and to measure a length of a clearance separating the two elements.

The measurement system is particularly effective when using one or several laser profilometers as sensors. This type of sensor makes it possible to measure a length remotely by sending a laser beam and receiving a return signal from the laser beam.

According to one aspect of the present disclosure, the finger is further capable of being arranged relative to the guide in a retracted position in which the finger is outside the rotational path of the rotating blade when the measurement system is in the mounted position.

This arrangement allows several clearance measurements to be performed on several rotating blades without having to move the measurement system from the mounted position. This represents a time saving for performing the measurements desired for inspecting rotating blades.

According to one aspect of the present disclosure, the retractable stop mechanism comprises a return element configured to automatically move the finger from the retracted position to the deployed position.

In addition, the retractable stop mechanism comprises an operating handle for manually moving the finger from the deployed position to the retracted position. It is therefore sufficient to pull the operating handle when changing the rotating blade.

According to one aspect of the present disclosure, the removable fastening device is a fastening flange adapted to be removably fastened to a receiving flange of the casing. In particular, the receiving flange is located at a lower location on the casing, in vertical alignment with an axis of rotation of the rotating blade.

This position corresponds to the six o'clock position.

In one aspect, the fastening flange comprises two rods capable of engaging in two corresponding holes in the casing in the mounted position. Since only one location in the mounted position is provided, it is easy for the operator to arrange the measurement system in the mounted position.

The locking mechanism comprises two rotary levers capable of being arranged in a locked position to hold the fastening flange on the casing.

According to one aspect of the present disclosure, the three measurement planes have an inclined direction relative to a vertical plane passing through the axis of rotation of the rotating blade.

This arrangement facilitates the measurement since the rotating blade extends in an inclined manner relative to the axis of rotation. The three measurement planes are thus adapted to measure three clearances along the rotating blade.

According to one aspect of the present disclosure, the guide and the finger of the retractable stop mechanism also extend at an inclination substantially identical to that of the measurement planes relative to the axis of rotation. The measurement system is thus adapted to the inclined profile of the rotating blade.

According to one aspect of the present disclosure, the plate extends in the mounted position along a mounting axis substantially parallel to the axis of rotation of the rotating blade. In one aspect, the three sensors are oriented in an inclined manner relative to the mounting axis.

A recess in the plate allows at least one of the sensors to be mounted in a recessed position along the mounting axis so as to allow the rotation of the rotating blade when the finger of the retractable stop mechanism is in the retracted position.

According to one aspect of the present disclosure, the measurement system comprises a data analysis terminal, such as a computer on a mobile cart, and a transmission cable capable of connecting the remote acquisition device to the data analysis terminal.

Therefore, the raw data obtained by the sensors is processed in such a way as to obtain the three clearances per rotating blade and for several rotating blades.

According to one aspect of the present disclosure, the measurement system can be configured to measure at least one positioning, for example to detect a correct positioning, of at least one platform 130 of the turbomachine, for example intended to be mounted in a gap which extends circumferentially between two adjacent rotating blades, for example the correct positioning of the at least one platform of the turbomachine mounted in a gap which extends circumferentially between two adjacent rotating blades.

In one aspect, between two blades, for example two rotating blades, for example on the side of the roots of the two blades, for example adjacent rotating blades, for example at or near the roots, for example in order to delimit, for example on the inner or central side, an annular gas flow channel, the channel being delimited, for example on the outer or peripheral side, by a corresponding casing portion of the turbomachine.

According to one aspect of the present disclosure, the system comprises a detector configured to measure the positioning, for example to detect the correct positioning, of the at least one platform of the turbomachine. In one aspect, the detector is attached to the plate.

It is advantageous to take advantage of the plate and the measurements already performed to also check the correct positioning of the platforms.

The present disclosure also relates to an intermediate production assembly comprising a casing, a rotating wheel, a fan blading, and a measurement system as described above.

The present disclosure also relates to a method for measuring at least one clearance between a rotating blade and a casing of a turbomachine, the rotating blade having an end surface facing an abradable material of the casing covering an inner part of the casing, the measurement method comprising the following steps: arranging a measurement system as described above, adapting, in a form-fitting manner, to the complementary location of the casing, the measurement system in the mounted position, then locking the removable fastening device in the mounted position on the casing with the locking mechanism, moving the blading comprising the rotating blade about the axis of rotation of the blading relative to the casing to bring the rotating blade into abutment against a dedicated surface of the finger when the finger is in the deployed position so as to hold the rotating blade in the measurement position, measuring at least one clearance between the rotating blade in the measurement position and the abradable material of the casing with the remote acquisition device.

According to one aspect of the present disclosure, following the step of adaptation by form-fitting, the following steps can be performed optionally if desired: moving a blading about the axis of rotation to bring the rotating blade into the measurement position or close to the measurement position, if desired by arranging the finger of the retractable stop mechanism in the retracted position, arranging or ensuring that the finger of the retractable stop mechanism is in the deployed position.

In one aspect, following the measurement, the method comprises a step consisting in recording the at least one measurement of the at least one clearance in a memory of the measurement system.

The measurement method is easy to perform and consists in correctly setting up the measurement system so that the remote acquisition device can accurately measure at least one clearance.

The removable fastening device and the retractable stop mechanism make it possible in particular to obtain excellent reproducibility and repeatability of the measurements performed since the relative position of the casing, the rotating blade and the remote acquisition device are strictly identical at each setup and measurement with the measurement system.

In practice, the measurement method is quick to perform by the operator responsible for measuring the at least one clearance and the results obtained are reliable.

According to one aspect of the present disclosure, following the step of measuring at least one clearance between the rotating blade and the abradable material of the casing, the method comprises the following additional steps: arranging the finger of the retractable stop mechanism in the retracted position, then, moving the blading about the axis of rotation to bring an additional rotating blade into the measurement position or close to the measurement position, arranging the finger of the retractable stop mechanism in the deployed position, then, arranging the additional rotating blade into abutment against the dedicated surface of the finger when the finger is in the deployed position so as to hold the additional rotating blade in the measurement position, measuring at least one additional clearance between the additional rotating blade in the measurement position and the abradable material of the casing with the remote acquisition device, recording the measurement of the at least one additional clearance in the memory of the measurement system.

Advantageously, the measurement system can remain in the mounted position when a measurement of at least one clearance needs to be taken on an additional rotating blade.

It is sufficient to arrange the finger of the retractable stop mechanism in the retracted position to allow the blading to rotate and to arrange the additional rotating blade in the measurement position or close to the measurement position.

By the term “close to”, it is understood that the additional rotating blade is brought to a location allowing the finger to be deployed, and then a further rotation of the additional rotating blade makes it possible to bring the latter into abutment against the finger.

According to one aspect of the present disclosure, the additional steps are repeated a number of times corresponding to a number of additional rotating blades to be measured.

According to one aspect of the present disclosure, the measurement method comprises a preliminary step consisting in measuring relief disparities of an inner portion of the abradable material intended to face the blading.

This arrangement allows for a 360° view of any irregularities in the inner portion of the abradable material. Indeed, it is desirable to identify any indentations or bumps in the abradable material that could modify the clearance between the rotating blade and the casing depending on the clock position of the rotating blade.

According to one aspect of the present disclosure, the measurement of disparities is performed by a regularity control device comprising a base suitable for mounting on a turbomachine rotor intended to receive the blading.

Mounting of the regularity control device is performed in the absence of the blading, in particular before the blading is mounted during manufacturing.

The regularity control device is thus capable of moving about the axis of rotation and further comprises at least one comparator intended to measure by contact a relief of the abradable material, the comparator being capable of determining a dimension of the relief as well as a clock position of the relief.

In one aspect, the regularity control device comprises three comparators spaced axially along the axis of rotation.

According to one aspect of the present disclosure, the measurements of the relief disparities are considered to determine, from the clearance measurements performed by the measurement system, an actual minimum clearance for each rotating blade concerned.

In one aspect, a rotor deflection determined by calculation is also considered.

Thus, the measurement system and method presented above are advantageous in the sense that only one measurement at a six o'clock position is desired to determine at least one minimum clearance of a rotating blade.

The various aspects defined above, which are not incompatible, can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a top view of a measurement system.

FIG. 2 is a rear view of the measurement system.

FIG. 3 is a perspective view of the measurement system.

FIG. 4 is a rear perspective view of the measurement system mounted on a turbomachine casing.

FIG. 5 is a detailed perspective view of the measurement system mounted on the casing and a blading comprising a rotating blade.

FIG. 6 is a schematic view of the measurement system and a portion of the turbomachine comprising the casing and the blading.

FIG. 7 is a diagram representing the steps of a measurement method.

FIG. 8 is a side view of a regularity control device.

FIG. 9 is a rear perspective view of the measurement system mounted on a turbomachine casing and configured to measure at least one positioning of at least one platform of the turbomachine.

FIG. 10 is a diagram representing the steps of a measurement method.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or elements performing identical functions may retain the same references in order to simplify the understanding of the present disclosure.

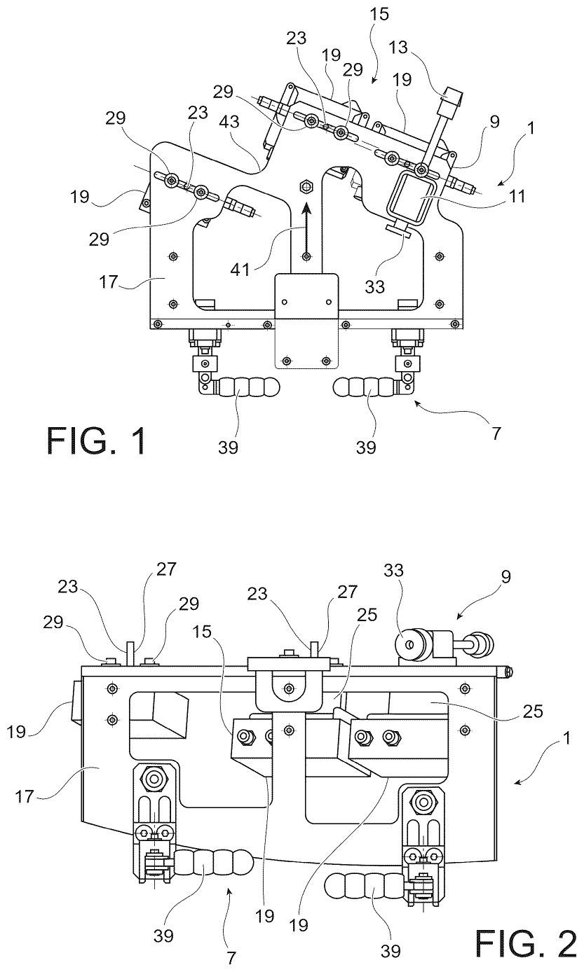

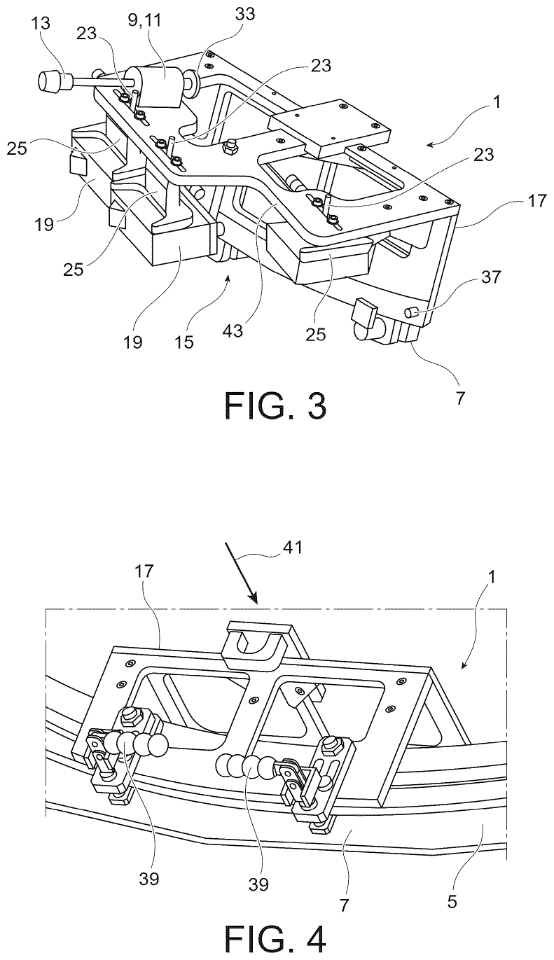

As illustrated in FIGS. 1 to 6, a system 1 for measuring a clearance between a rotating blade 3 and a casing 5 of a turbomachine comprises a removable fastening device 7 shaped to adapt, in a form-fitting manner, to a complementary location of the casing 5 in a mounted position.

The removable fastening device 7 is provided with a locking mechanism to maintain the mounted position of the measurement system 1 on the casing 5.

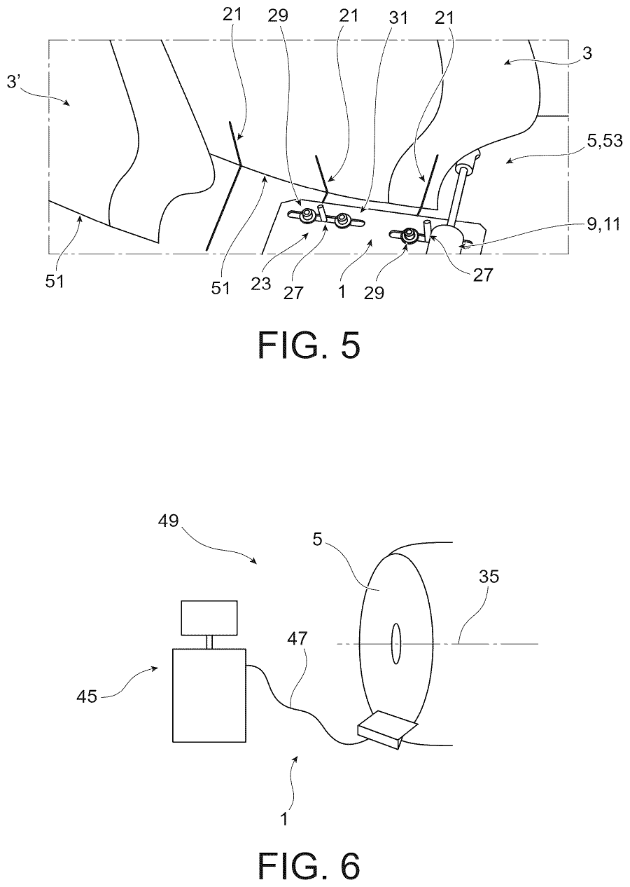

The measurement system 1 comprises a retractable stop mechanism 9 provided with a guide 11 and a finger 13 capable of being arranged relative to the guide 11 in a deployed position in which the finger 13 is configured to hold the rotating blade 3 in a measurement position as illustrated in FIG. 5.

The measurement system 1 comprises a remote acquisition device 15 configured to measure at least one clearance between the rotating blade 3 and the casing 5 when the removable fastening device 7 is in the mounted position and the retractable stop mechanism 9 is in the deployed position.

The measurement system 1 also comprises a plate 17 to which the removable fastening device 7, the retractable stop mechanism 9 and the remote acquisition device 15 are attached.

Thus, the measurement system 1 is a specific tool with a device 15 for remotely acquiring a measurement that can be removably fastened on the casing 5 and block the rotating blade 3 in the measurement position.

The remote acquisition device 15 comprises at least one sensor 19 configured to measure a clearance corresponding to a minimum distance between the rotating blade 3 and the casing 5 in a corresponding measurement plane 21 of the sensor 19. Here, the remote acquisition device 15 comprises three sensors 19.

In other words, each sensor 19 is configured to detect in the corresponding measurement plane 21 a point on the rotating blade 3 and a point on the casing 5 with the smallest distance and then to measure this distance.

The measurement system 1 comprises, for each sensor 19, a corresponding device 23 for adjusting the relative position of the sensor 19 with respect to the plate 17 so as to define the positioning of the corresponding measurement plane 21 of the sensor 19 with respect to the plate 17.

As illustrated in FIG. 5, each measurement plane 21 is positioned so as to be transverse and in particular normal to the casing 5 at the location of the measured clearance.

Each adjustment device 23 comprises a support 25 configured to receive the corresponding sensor 19, the support 25 being provided with an adjustment pin 27 whose movement allows the position of the sensor 19 with respect to the plate 17 to be changed.

Each adjustment device 23 comprises a clamping element 29 to maintain the relative position of the support 25 with respect to the plate 17. In particular, the clamping element 29 comprises two screws configured to cooperate with two corresponding threads of the support 25.

As illustrated in FIG. 5, the screws are configured to extend through at least one through-opening 31 of the plate 17 to provide that the support 25 is secured to the plate 17.

Here, the remote acquisition device 15 comprises three sensors 19 configured to measure three clearances corresponding to three minimum distances between the rotating blade 3 and the casing 5 in three corresponding measurement planes 21.

The sensors 19 are arranged so that the three measurement planes 21 are substantially parallel.

Each sensor 19 is a laser profilometer adapted to identify two distinct elements and to measure a length of a clearance separating the two elements. This type of sensor makes it possible to measure a length remotely by sending a laser beam and receiving a return signal from the laser beam.

Regarding the retractable stop mechanism 9, the finger 13 is further capable of being arranged relative to the guide 11 in a retracted position in which the finger 13 is outside the rotational path of the rotating blade 3 when the measurement system 1 is in the mounted position.

The retractable stop mechanism 9 comprises a return element configured to automatically move the finger 13 from the retracted position to the deployed position.

In addition, the retractable stop mechanism 9 comprises an operating handle 33 for manually moving the finger 13 from the deployed position to the retracted position. It is thus sufficient to pull the operating handle 33 when changing the rotating blade 3.

The removable fastening device 7 is a fastening flange adapted to be removably fastened to a receiving flange of the casing 5. In particular, the receiving flange is located at a lower location of the casing 5 in vertical alignment with an axis of rotation 35 of the rotating blade 3. This position corresponds to the six o'clock position.

The fastening flange comprises two rods 37 capable of engaging in two corresponding holes in the casing 5 in the mounted position. Since only one location in the mounted position is provided, it is easy for the operator to arrange the measurement system 1 in the mounted position.

The locking mechanism comprises two rotary levers 39 capable of being arranged in a locked position to hold the fastening flange on the casing 5.

The three measurement planes 21 have an inclined direction relative to a vertical plane passing through the axis of rotation 35 of the rotating blade 3. This arrangement facilitates the measurement since the rotating blade 3 extends in an inclined manner relative to the axis of rotation 35.

The guide 11 and the finger 13 of the retractable stop mechanism 9 also extend at an inclination substantially identical to that of the measurement planes 21 relative to the axis of rotation 35. The measurement system 1 is thus adapted to the inclined profile of the rotating blade 3.

The plate 17 extends in the mounted position along a mounting axis 41 substantially parallel to the axis of rotation 35 of the rotating blade 3. The three sensors 19 are oriented in an inclined manner relative to the mounting axis 41.

A recess 43 of the plate 17 allows one of the sensors 19 to be mounted in a recessed position along the mounting axis 41 so as to allow the rotation of the rotating blade 3 when the finger 13 of the retractable stop mechanism 9 is in the retracted position.

As illustrated in FIG. 6, the measurement system 1 comprises a data analysis terminal 45, such as a computer on a mobile cart, and a transmission cable 47 capable of connecting the remote acquisition device 15 to the data analysis terminal 45.

Therefore, the raw data obtained by the sensors 19 are processed in such a way as to obtain the three clearances per rotating blade 3 and for several rotating blades 3.

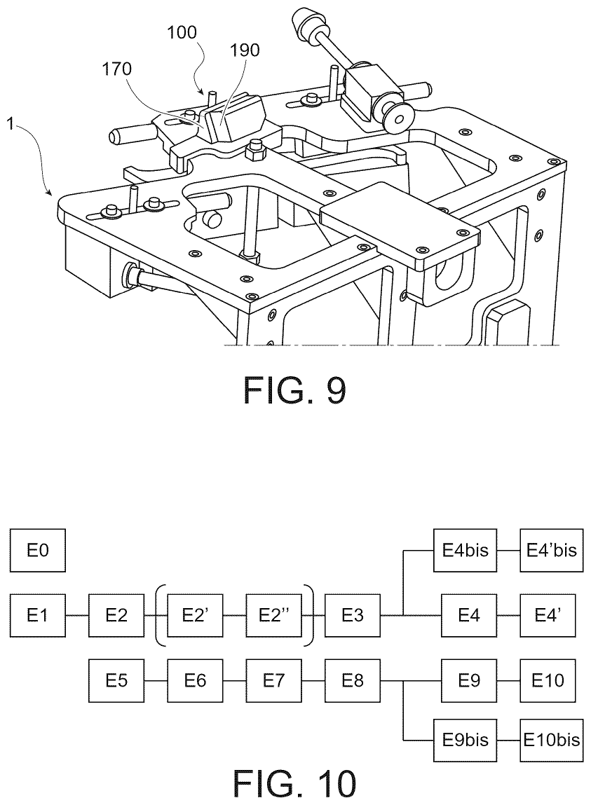

As illustrated in FIG. 9, the measurement system 1 can be configured to measure at least one positioning, for example to detect a correct positioning, of at least one platform of the turbomachine, for example intended to be mounted in a gap which extends circumferentially between two adjacent rotating blades 3, for example the correct positioning of the at least one platform of the turbomachine mounted in a gap which extends circumferentially between two adjacent rotating blades 3.

Each platform is for example positioned between two blades, for example two rotating blades, for example on the side of the roots of the two blades 3, for example adjacent rotating blades, for example at or near the roots, for example in order to delimit, for example on the inner or central side, an annular gas flow channel, the channel being delimited, for example on the outer or peripheral side, by a corresponding casing portion of the turbomachine.

The system may, for example, comprise a detector 100 configured to measure the positioning, for example to detect the correct positioning, of the at least one platform of the turbomachine.

For example, alternatively or in combination with being configured to measure at least one clearance between the rotating blade 3 and the casing 5, the remote acquisition device 15 can be configured to measure the positioning, for example to detect the correct positioning, of the at least one platform of the turbomachine.

The remote acquisition device 15 may comprise the detector 100. Alternatively, the detector 100 may be separate from the remote acquisition device 15.

The detector 100 may comprise or be at least one sensor 190, for example a sensor 190 additional to the sensor(s) 19, for example a fourth sensor 190.

The detector 100 may be a position detector. The sensor 190 may be a position sensor 190, for example a laser sensor.

The detector 100 may be attached to the plate 17. It is advantageous to take advantage of the plate 17 and the measurements already performed to also check the correct positioning of the platforms.

The detector 100 can be attached to the plate on the side opposite to at least one, for example, the sensor(s) 19. The detector 100 may be attached to the plate on the same side as the retractable stop mechanism 9. The detector 100 can be attached to a board of the plate extending, in the mounted position, along the mounting axis 41. The board has, for example, a width and a length. The detector 100 is located, for example, on one side of the board in the width direction, for example, on a side opposite to a side from which the recess 43 extends. The detector 100 is located, for example, in a central area of the board in the length direction, for example, relative to the retractable stop mechanism 9 arranged on one side in the length direction. The detector is, for example, arranged at the same level as the sensor(s) 19, on an opposite side of the board with respect to the sensor(s) 19.

The detector 100 may comprise a sensor support 170, allowing, for example, the positioning of the sensor 190 relative to the plate 17. The sensor support 170 is, for example, an inclined support for positioning the sensor 190 in an inclined manner. The sensor support 170 comprises, for example, an inclined ramp. The sensor support 170 can be fastened to the plate 17, for example, by means of screws.

The detector 100 can be configured to measure the positioning of the at least one platform of the turbomachine, for example a relative position of the platform, for example of one or several walls of the platform, for example with respect to one and/or the other of the adjacent blades, for example when the removable fastening device 7 is in the mounted position and the retractable stop mechanism (9) is in the deployed position.

FIG. 6 schematically represents an intermediate production assembly 49 comprising a casing 5, a rotating wheel, a fan blading comprising a plurality of rotating blades 3, and a measurement system 1 as described above.

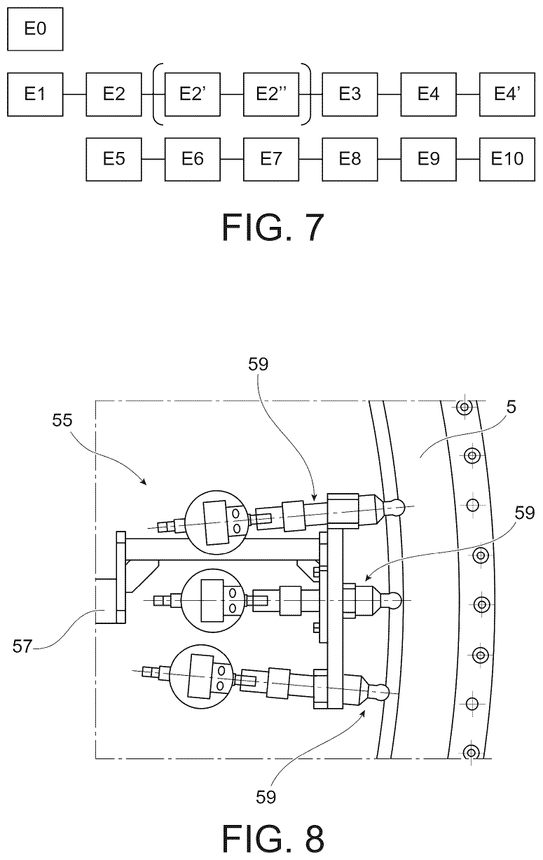

FIG. 7 represents a method for measuring at least one clearance between a rotating blade 3 and a casing 5 of a turbomachine, the rotating blade 3 having an end surface 51 facing an abradable material 53 of the casing 5 covering an inner part of the casing 5.

A step E1 consists in arranging a measurement system 1 as described above.

A step E2 consists in adapting, in a form-fitting manner, to the complementary location of the casing 5, the measurement system 1 in the mounted position, then locking the removable fastening device 7 in the mounted position on the casing 5 with the locking mechanism.

A step E2′, performed optionally if desired, consists in moving the blading about the axis of rotation 35 to bring the rotating blade 3 into the measurement position or close to the measurement position, if desired, by arranging the finger 13 of the retractable stop mechanism 9 in the retracted position.

A step E2″, performed optionally if desired, consists in arranging or ensuring that the finger 13 of the retractable stop mechanism 9 is in the deployed position.

A step E3 consists in moving the blading comprising the rotating blade 3 about an axis of rotation 35 of the blading relative to the casing 5 to bring the rotating blade 3 into abutment against a dedicated surface of the finger 13 when the finger 13 is in the deployed position so as to hold the rotating blade 3 in the measurement position.

A step E4 consists in measuring at least one clearance between the rotating blade 3 in the measurement position and the abradable material 53 of the casing 5 with the remote acquisition device 15.

A step E4′ consists in recording the at least one measurement of the at least one clearance in a memory of the measurement system 1. This memory is comprised in the data analysis terminal 45.

Following the step E4 of measuring at least one clearance between the rotating blade 3 and the abradable material 53 of the casing 5, the method may comprise the additional steps described below.

A step E5 consists in arranging the finger 13 of the retractable stop mechanism 9 in the retracted position.

A step E6 then consists in moving the blading about the axis of rotation 35 to bring an additional rotating blade 3′ into the measurement position or close to the measurement position,

A step E7 consists in arranging the finger 13 of the retractable stop mechanism 9 in the deployed position.

A step E8 consists in arranging the additional rotating blade 3′ into abutment against the dedicated surface of the finger 13 when the finger 13 is in the deployed position so as to hold the additional rotating blade 3′ in the measurement position.

A step E9 consists in measuring at least one additional clearance between the additional rotating blade 3′ in the measurement position and the abradable material 53 of the casing 5 with the remote acquisition device 15.

A step E10 consists in recording the measurement of the at least one additional clearance in the memory of the measurement system 1.

Advantageously, the measurement system 1 can remain in the mounted position when a measurement of at least one clearance needs to be taken on the additional rotating blade 3′.

It is sufficient to arrange the finger 13 of the retractable stop mechanism 9 in the retracted position to allow the rotation of the blading and to arrange the additional rotating blade 3′ in the measurement position or close to the measurement position.

By the term “close to”, it is understood that the additional rotating blade 3′ is brought to a location allowing the finger 13 to be deployed and then a further rotation of the additional rotating blade 3′ allows the latter to be brought into abutment against the finger 13.

The additional steps E5 to E10 are repeated a number of times corresponding to a number of additional rotating blades 3′ to be measured.

In addition, the measurement method may also comprise a preliminary step E0 consisting in measuring relief disparities of an inner portion of the abradable material 53 intended to face the blading.

This arrangement allows for a 360° view of any irregularities in the inner portion of the abradable material 53. Indeed, it is desirable to identify any indentations or bumps in the abradable material 53 that could modify the clearance between the rotating blade 3 and the casing 5 depending on the clock position of the rotating blade 3.

As illustrated in FIG. 8, the measurement of disparities is performed by a regularity control device 55 comprising a base 57 suitable for mounting on a turbomachine rotor intended to receive the blading.

Mounting of the regularity control device 55 is performed in the absence of the blading, in particular before the blading is mounted during manufacturing.

The regularity control device 55 is thus capable of moving about the axis of rotation 35 and further comprises at least one comparator 59 intended to measure by contact a relief of the abradable material 53, the comparator 59 being capable of determining a dimension of the relief as well as a clock position of the relief.

Here, the regularity control device 55 comprises three comparators 59 spaced axially along the axis of rotation 35.

The measurements of the relief disparities are considered to determine, from the clearance measurements performed by the measurement system 1, an actual minimum clearance for each rotating blade 3 concerned.

In one aspect, a rotor deflection determined by calculation is also considered.

Thus, the measurement system and method presented above are advantageous in the sense that only one measurement at a six o'clock position is desired to determine at least one minimum clearance of a rotating blade 3.

For the operator, installing the measurement system 1 in the mounted position is quick and easy. Positioning the rotating blade 3 is also simple to perform, since the measurement position is reached by abutment against the finger 13.

In addition, acquiring the measurement remotely eliminates the risks of scratching or damaging the rotating blade 3 or the casing 5.

As illustrated in FIG. 10, complementary or alternative steps may be added in the case where the system is configured to measure at least one positioning of at least one turbomachine platform.

Alternatively or in addition to step(s) E4, and/or E4′, the method may comprise step(s) E4bis, and/or E4′bis.

A step E4bis may consist in measuring the at least one positioning of the turbomachine platform adjacent to the blade in the measurement position with the detector, for example with the remote acquisition device 15.

A step E4′bis may consist in recording the at least one measurement of the at the least one positioning in the memory of the measurement system 1.

Alternatively or in addition to step(s) E9, and/or E10, the method may comprise step(s) E9bis, and/or E10bis.

A step E9bis may consist in measuring at least one additional positioning of the turbomachine platform adjacent to the blade in the measurement position with the remote acquisition device 15.

A step E10bis consists in recording the measurement of the at least one additional positioning in the memory of the measurement system 1.

Advantageously, the measurement system 1 can remain in the mounted position when a measurement of at least one positioning needs to be taken on the platform adjacent to the additional rotating blade 3′.

In combination with steps E5 to E8, and for example steps E9 and E10, the additional steps E9bis and E10bis are repeated a number of times corresponding to a number of additional platforms to be measured.

It goes without saying that the present disclosure is not limited to the sole variation described above as an example, on the contrary, it encompasses all variants thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A measurement system for measuring a clearance between a rotating blade and a casing of a turbomachine, the measurement system comprising:
a removable fastening device shaped to adapt, in a form-fitting manner, to a complementary location of the casing in a mounted position, the removable fastening device being provided with a locking mechanism to maintain the mounted position of the measurement system on the casing,
a retractable stop mechanism provided with a guide and a finger configured to be arranged relative to the guide in a deployed position in which the finger is configured to hold the rotating blade in a measurement position,
a remote acquisition device configured to measure at least one clearance between the rotating blade and the casing when the removable fastening device is in the mounted position and the retractable stop mechanism is in the deployed position, and
a plate to which the removable fastening device, the retractable stop mechanism and the remote acquisition device are attached.

2. The measurement system according to claim 1, wherein the remote acquisition device comprises at least one sensor configured to measure a clearance corresponding to a minimum distance between the rotating blade and the casing in a corresponding measurement plane of the at least one sensor.

3. The measurement system according to claim 2, further comprising at least one device for adjusting a relative position of the at least one sensor with respect to the plate so as to define a positioning of the corresponding measurement plane of the at least one sensor with respect to the plate.

4. The measurement system according to claim 2, wherein the remote acquisition device comprises three sensors configured to measure three clearances corresponding to three minimum distances between the rotating blade and the casing in three corresponding measurement planes.

5. The measurement system according to claim 2, wherein the at least one sensor is a laser profilometer adapted to identify two distinct elements and to measure a length of a clearance separating the two distinct elements.

6. The measurement system according to claim 1, wherein the finger is configured to be arranged relative to the guide in a retracted position in which the finger is outside a rotational path of the rotating blade when the measurement system is in the mounted position.

7. The measurement system according to claim 1, wherein the removable fastening device is a fastening flange adapted to be removably fastened to a receiving flange of the casing.

8. A method for measuring at least one clearance between a rotating blade and a casing of a turbomachine, the rotating blade having an end surface facing an abradable material of the casing covering an inner part of the casing, the method comprising:
arranging a measurement system according to claim 1,
adapting, in a form-fitting manner, to the complementary location of the casing, the measurement system in the mounted position, then locking the removable fastening device in the mounted position on the casing with the locking mechanism,
moving blading comprising the rotating blade about an axis of rotation of the blading relative to the casing to bring the rotating blade into abutment against a dedicated surface of the finger when the finger is in the deployed position so as to hold the rotating blade in the measurement position, and
measuring at least one clearance between the rotating blade in the measurement position and the abradable material of the casing with the remote acquisition device.

9. The method according to claim 8, wherein, following the measuring at least one clearance between the rotating blade and the abradable material of the casing, the method further comprises:
arranging the finger of the retractable stop mechanism in a retracted position, then,
moving the blading about the axis of rotation to bring an additional rotating blade into the measurement position or close to the measurement position,
arranging the finger of the retractable stop mechanism in the deployed position, then,
arranging the additional rotating blade into abutment against the dedicated surface of the finger when the finger is in the deployed position so as to hold the additional rotating blade in the measurement position,
measuring at least one additional clearance between the additional rotating blade in the measurement position and the abradable material of the casing with the remote acquisition device, and
recording a measurement of the at least one additional clearance in a memory of the measurement system.

10. The method according to claim 8, further comprising a preliminary measuring relief disparities of an inner portion of the abradable material intended to face the blading.
